(19) United States
(12) Patent Application Publication
(10) Pub. No.: US 2024/0311301 A1
(43) Pub. Date: Sep. 19, 2024

(54) MEMORY DEVICE FLUSH BUFFER OPERATIONS

(71) Applicant: Rambus Inc., San Jose, CA (US)

(72) Inventors: Michael Raymond MILLER, Raleigh, NC (US); Steven C. Woo, Saratoga, CA (US); Wendy Elsasser, Austin, TX (US); Taeksang Song, San Jose, CA (US)

(21) Appl. No.: 18/598,142

(22) Filed: Mar. 7, 2024

Related U.S. Application Data
(60) Provisional application No. 63/526,352, filed on Jul. 12, 2023.
(60) Provisional application No. 63/452,830, filed on Mar. 17, 2023.

(51) Int. Cl. G06F 12/0804

(52) U.S. Cl. CPC G06F 12/0804

(57) ABSTRACT

A dynamic random access memory (DRAM) device includes functions configured to aid with operating the DRAM device as part of data caching functions. In response to some write and/or read access commands, the DRAM device is configured to copy a cache line (e.g., dirty cache line) from the main DRAM memory array, place it in a flush buffer, and replace the copied cache line in the main DRAM memory array with a new (e.g., different) cache line of data. In response to conditions and/or events (e.g., explicit command, refresh, write-to-read command sequence, unused data bus bandwidth, full flush buffer, etc.) the DRAM device transmits the cache line from the flush buffer to the controller. The controller may then transmit the cache line to other cache levels.

### BRIEF DESCRIPTION OF THE DRAWINGS

FIGS. 1A-1F are diagrams illustrating a memory system and memory device flush buffer operations.

FIGS. 2A-2G are diagrams illustrating a memory system and caching adapted memory device operations.

FIG. 3 is a flowchart illustrating a method of operating a memory component with a flush buffer.

FIG. 4 is a flowchart illustrating a method of operating a memory controller.

FIG. 5 is a flowchart illustrating a method of operating a memory component having cache tag based flush buffer management.

FIG. 6 is a flowchart illustrating a method of operating a controller to use cache tag based flush buffer management.

FIG. 7 is a block diagram of a processing system.

### DETAILED DESCRIPTION OF THE EMBODIMENTS

In an embodiment, a dynamic random access memory (DRAM) device includes functions configured to aid with operating the DRAM device as part of data caching functions. In response to some write access commands, the DRAM device is configured to copy a cache line (e.g., dirty cache line) from the main DRAM memory array, place it in a flush buffer, and replace the copied cache line in the main DRAM memory array with a new (e.g., different) cache line of data. In response to conditions and/or events (e.g., explicit command, refresh, write-to-read command sequence, read-clean-miss, unused data bus bandwidth, full flush buffer, etc.) the DRAM device transmits the cache line from the flush buffer to the controller. The controller may then transmit the cache line to other cache levels, main memory, a processor, and/or another controller.

In an embodiment, the DRAM device also stores cache tag and cache flag values (e.g., clean, dirty, etc.). Thus, the DRAM device may use these cache tag values and cache flag values to determine whether to copy the cache line to the flush buffer before replacing it (e.g., upon a write miss dirty condition), or to simply replace it in the main DRAM array (e.g., write miss clean condition or write hit condition). The cache tag and cache flag values may also be used to select times/transactions having conditions (e.g., miss clean) that indicate the data bus will be available to transmit an entry from the flush buffer to the controller.

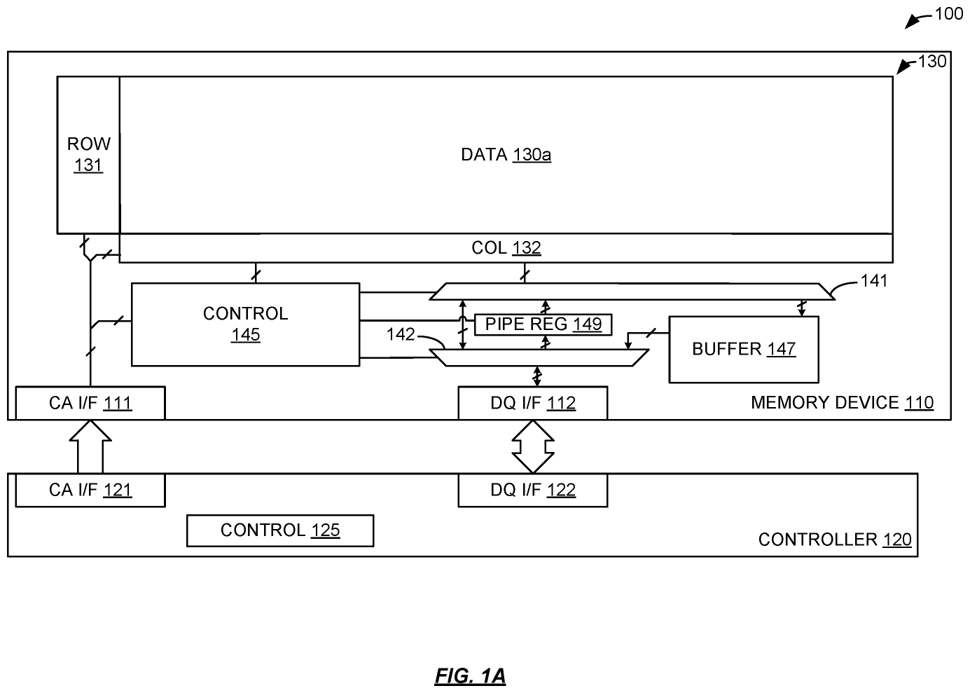

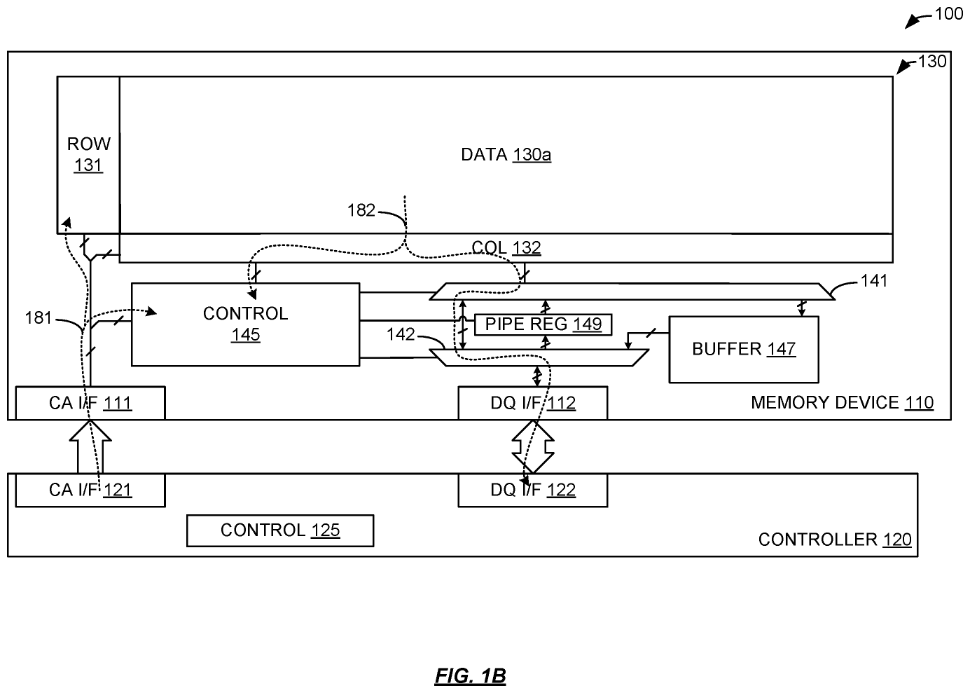

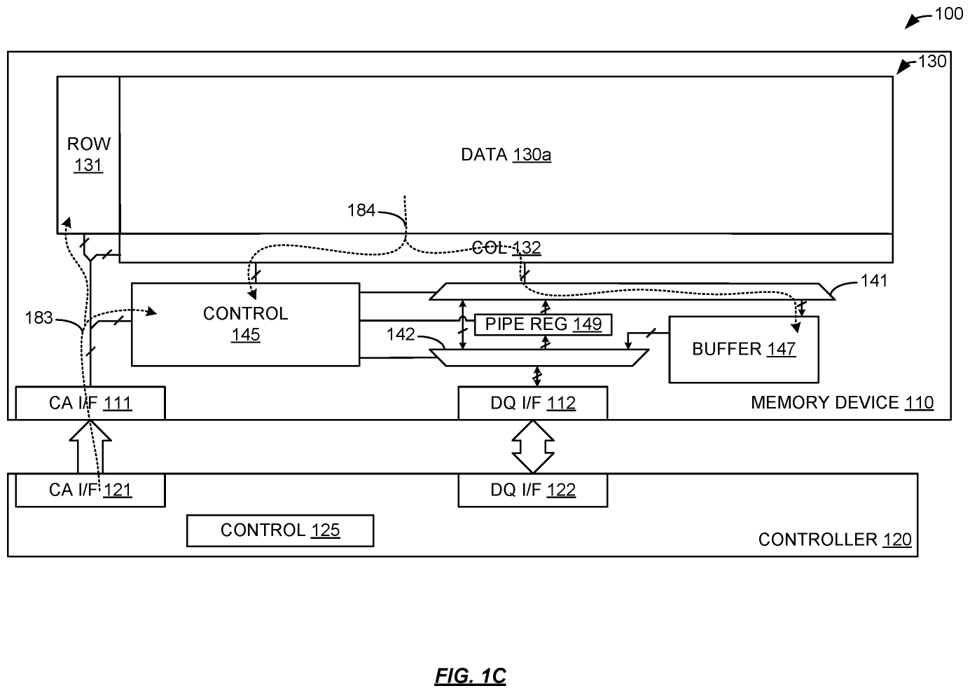

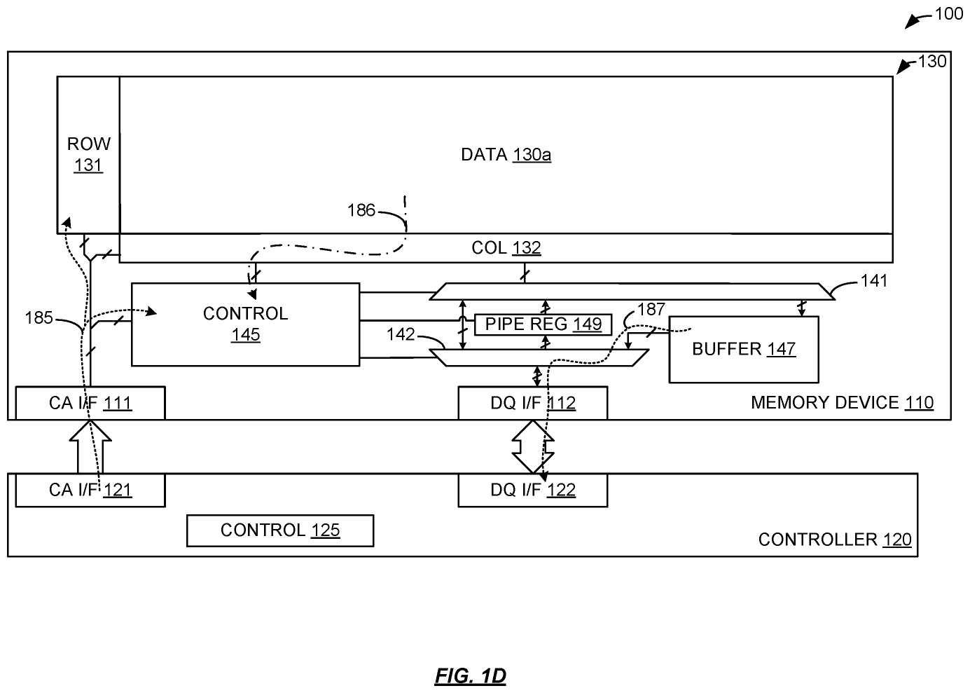

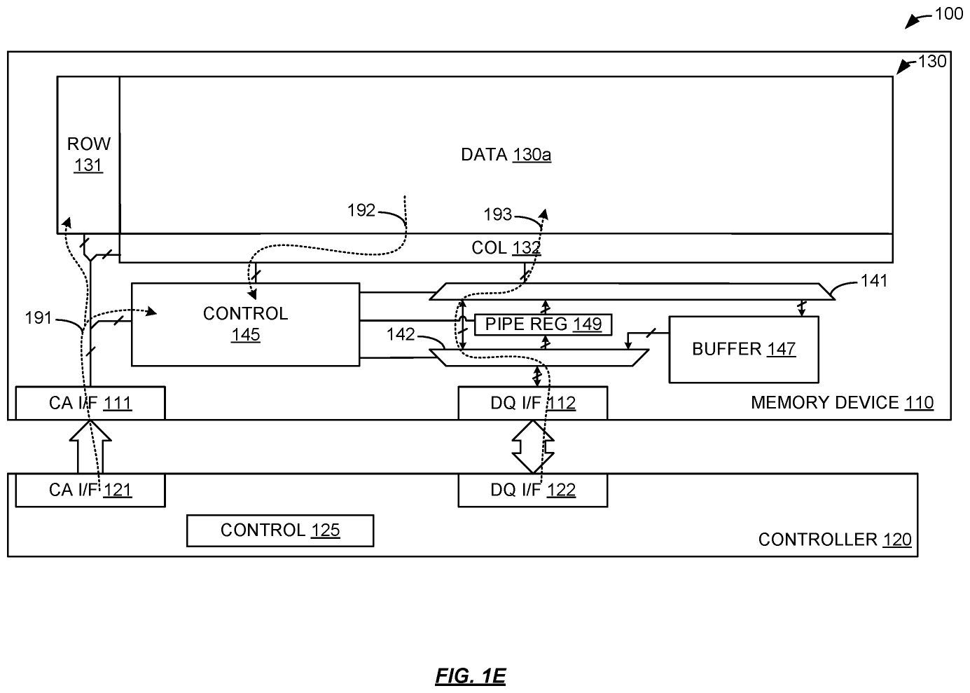

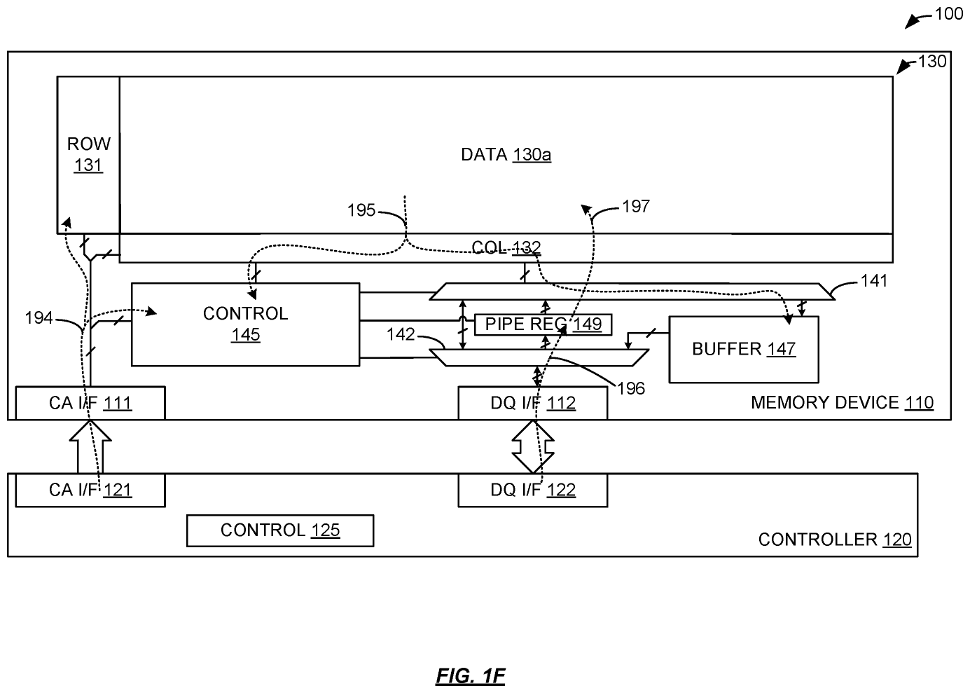

FIGS. 1A-1F are diagrams illustrating a memory system and memory device flush buffer operations. In FIGS. 1A-1F, memory system 100 comprises memory device 110 and memory controller 120. Memory device 110 includes command/address (CA) interface 111, data (DQ) interface 112, memory array 130, row circuitry 131, column circuitry 132, steering circuitry 141, steering circuitry 142, control circuitry 145, buffer circuitry 147, and pipeline register 149. The rows and columns of memory array 130 may be organized into rows and columns of memory array tiles (MATs). Rows of data 130a (e.g., cache line data, cache tags cache flags, etc.) is stored by memory array 130 and accessed via column circuitry 132. Memory controller 120 includes CA interface 121, DQ interface 122, and control circuitry 125. Controller 120 may be operatively coupled to additional cache levels (not shown in FIG. 1), main memory (not shown in FIG. 1), and/or backing store (not shown in FIG. 1).

CA interface 121 of controller 120 is operatively coupled to CA interface 111 of memory device 110. CA interface 121 of controller 120 is operatively coupled to CA interface 111 of memory device 110 to at least communicate, from controller 120, commands and addresses to memory device 110. DQ interface 122 of controller 120 is operatively coupled to DQ interface 112 of memory device 110. DQ interface 122 of controller 120 is operatively coupled to DQ interface 112 of memory device 110 to communicate data (e.g., cache lines, dirty cache lines, cache line fill data) between controller 120 and memory device 110.

Memory controller 120 and memory device 110 may be integrated circuit type devices, such as are commonly referred to as “chips”. A memory controller, such as memory controller 120, manages the flow of data going to and from memory devices and/or memory modules. Memory device 110 may be a standalone device, or may be a component of a memory module such as a DIMM module used in servers. Memory device 110 may be, or be part of, a component having a “stack” of memory devices. Memory device 110 may be a device that adheres to, or is compatible with, a dynamic random access memory (DRAM) specification. A memory controller can be a separate, standalone chip, or integrated into another chip. For example, a memory controller 120 may be included on a single die with a microprocessor, included as a chip co-packaged with one or more microprocessor chips, included as part of a more complex integrated circuit system such as a block of a system on a chip (SOC), or be remotely coupled to one or more microprocessors via a fabric interconnect or other type of interconnect.

CA interface 111 of memory device 110 is operatively coupled to row circuitry 131, column circuitry 132, and control circuitry 145. CA interface 111 is operatively coupled to row circuitry 131 to at least to activate rows in memory array 130. CA interface 111 is operatively coupled to column circuitry 132 to at least sense values from activated rows, and to decode and provide the values of selected columns to other circuitry of memory device 110 (e.g., control circuitry 145, DQ interface 112, steering circuitry 141, steering circuitry 142, etc.).

Steering circuitry 141 is operatively coupled to control circuitry 145, column circuitry 132, steering circuitry 142, buffer circuitry 147, and pipeline register 149. Steering circuitry 141 is operatively coupled to steering circuitry 142, buffer circuitry 147, and pipeline register 149 to, under the control of control circuitry 145, communicate data between memory array 130 (and column circuitry 132, in particular) and a selected one of steering circuitry 142, buffer circuitry 147, and pipeline register 149.

Steering circuitry 142 is operatively coupled to control circuitry 145, DQ interface 112, steering circuitry 141, buffer circuitry 147, and pipeline register 149. Steering circuitry 142 is operatively coupled to DQ interface 112, steering circuitry 141, buffer circuitry 147, and pipeline register 149 to, under the control of control circuitry 145, communicate data between DQ interface 112, and a selected one of steering circuitry 141, buffer circuitry 147, and pipeline register 149.

In an embodiment, controller 120, under the control of control circuitry 125, transmits an access command (e.g., read command) to memory device 110. This is illustrated in FIG. 1B by arrow 181 running from CA interface 121 through CA interface 111 to row circuitry 131 and control circuitry 145. Based on one or more indicators, the access command results in the accessed cache line from memory device 110 being transmitted to controller 120 without first being stored in buffer circuitry 147. In particular, in an embodiment, based on a first indicator (e.g., command opcode, command operand, command field value, cache tag match status, cache flag, etc.), control circuitry 145 configures memory device 110 (and steering circuitry 141 and steering circuitry 142, in particular) to route data 130a accessed from memory array 130 to controller 120 via column circuitry 132, steering circuitry 141, steering circuitry 142, DQ interface 112, and DQ interface 122. This is illustrated in FIG. 1B by arrow 182 running from data 130a to control circuitry 145 and also running from data 130a through steering circuitry 141, through steering circuitry 142, through DQ interface 112, to DQ interface 122.

In an embodiment, controller 120, under the control of control circuitry 125, transmits an access command (e.g., read command) to memory device 110. This is illustrated in FIG. 1C by arrow 183 running from CA interface 121 through CA interface 111 to row circuitry 131 and control circuitry 145. Based on one or more indicators, the access command results in the accessed cache line from memory device 110 being stored in buffer circuitry 147 without being immediately (or a fixed time later) transmitted to controller 120 via DQ interface 112. In particular, in an embodiment, based on a second indicator (e.g., command opcode, command operand, command field value, cache tag match status, cache flag, etc.), control circuitry 145 configures memory device 110 (and steering circuitry 141, in particular) to route data 130a accessed from memory array 130 to buffer circuitry 147 via column circuitry 132, and steering circuitry 141. This is illustrated in FIG. 1C by arrow 184 running from data 130a to control circuitry 145 and also running from data 130a through steering circuitry 141 to buffer circuitry 147.

In an embodiment, controller 120, under the control of control circuitry 125, transmits an access command (e.g., buffer flush command, buffer read command, etc.) to memory device 110 that results in data being accessed from buffer circuitry 147 rather than memory array 130. This is illustrated in FIG. 1D by arrow 185 running from CA interface 121 through CA interface 111 to row circuitry 131 and control circuitry 145. Based on one or more indicators, the access command results in a cache line from buffer circuitry 147 being transmitted to controller 120 via DQ interface 112. In particular, in an embodiment, based on a third indicator (e.g., command opcode, command operand, command field value, cache tag match status, cache flag, etc.), control circuitry 145 configures memory device 110 (and steering circuitry 142, in particular) to route data accessed from buffer circuitry 147 to DQ interface 112 for transmission to controller 120. Situations needing an access to cache tags are illustrated in FIG. 1D by arrow 186 (e.g., in the case of a “read miss” which relies upon the cache tags). Situations that do not need an access to cache tags may be excluded from being illustrated by arrow 186 (e.g., in the cases of an explicit buffer flush or buffer read command which do not need to access the cache tags). Both situations are further illustrated in FIG. 1D by arrow 187 running from buffer circuitry 147 through steering circuitry 142 to DQ interface 112 and DQ interface 122.

In an embodiment, controller 120, under the control of control circuitry 125, transmits an access command (e.g., write command) to memory device 110. This is illustrated in FIG. 1E by arrow 191 running from CA interface 121 through CA interface 111 to row circuitry 131 and control circuitry 145. Based on one or more indicators, the access command results in the cache line from controller 120 being written to memory array 130 without data from memory array 130 being stored in buffer circuitry 147. In particular, in an embodiment, based on a first indicator (e.g., command opcode, command operand, command field value, cache tag match status, cache flag, etc.), control circuitry 145 configures memory device 110 (and steering circuitry 141 and steering circuitry 142, in particular) to route data from controller 120 to column circuitry 132 via DQ interface 112, steering circuitry 142, and steering circuitry 141. This is illustrated in FIG. 1E by arrow 192 running from data 130a to control circuitry 145 (illustrating an example optional cache match status and/or cache flag value) and by arrow 193 running from DQ interface 122 through DQ interface 112, through steering circuitry 142, and through steering circuitry 141 to column circuitry 132.

In an embodiment, controller 120, under the control of control circuitry 125, transmits an access command (e.g., write command) to memory device 110. This is illustrated in FIG. 1F by arrow 194 running from CA interface 121 through CA interface 111 to row circuitry 131 and control circuitry 145. Based on one or more indicators, the access command results in the data from memory array 130, which is in the location targeted to be written by controller 120, being stored in buffer circuitry 147. In particular, in an embodiment, based on a first indicator (e.g., command opcode, command operand, command field value, cache tag match status, cache flag, etc.), control circuitry 145 configures memory device 110 (and steering circuitry 141 and steering circuitry 142, in particular) to route data from controller 120 to pipeline register 149, data from column circuitry 132 to buffer circuitry 147, and the data from controller 120, after being held for a time in pipeline register 149 being routed to column circuitry 132. This is illustrated in FIG. 1F by arrow 195 running from data 130a to control circuitry 145 (illustrating an example optional cache match status and/or cache flag value) and running to buffer circuitry 147 and is also illustrated by arrow 196 running from DQ interface 122 through DQ interface 112, through steering circuitry 141, to pipeline register 149 and is also illustrated by arrow 197 running from pipeline register 149 through steering circuitry 141 to column circuitry 132.

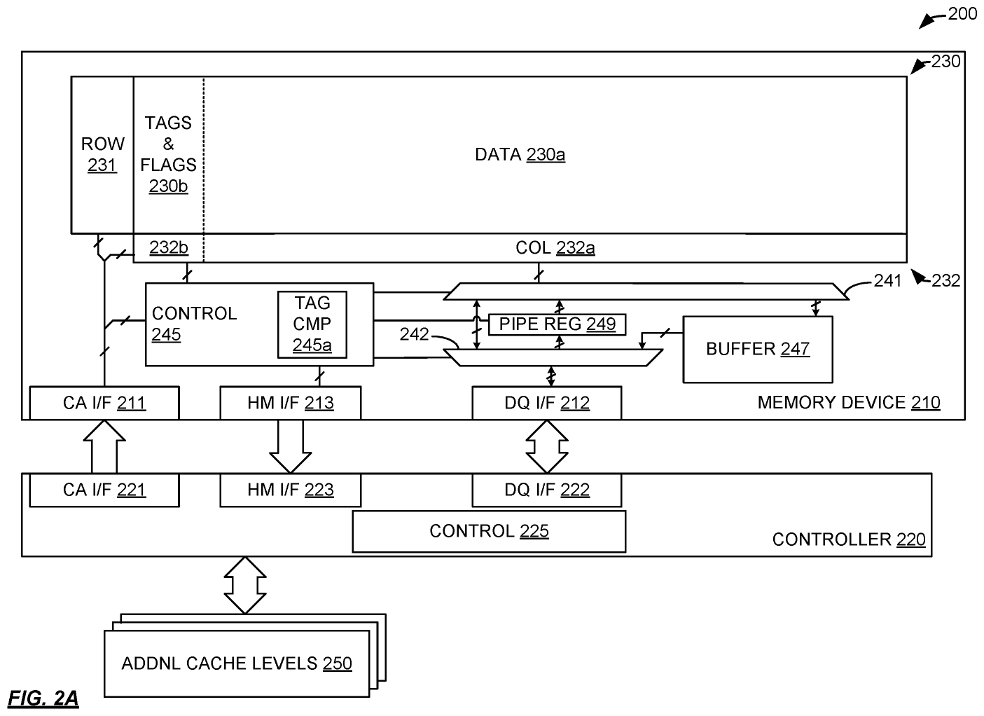

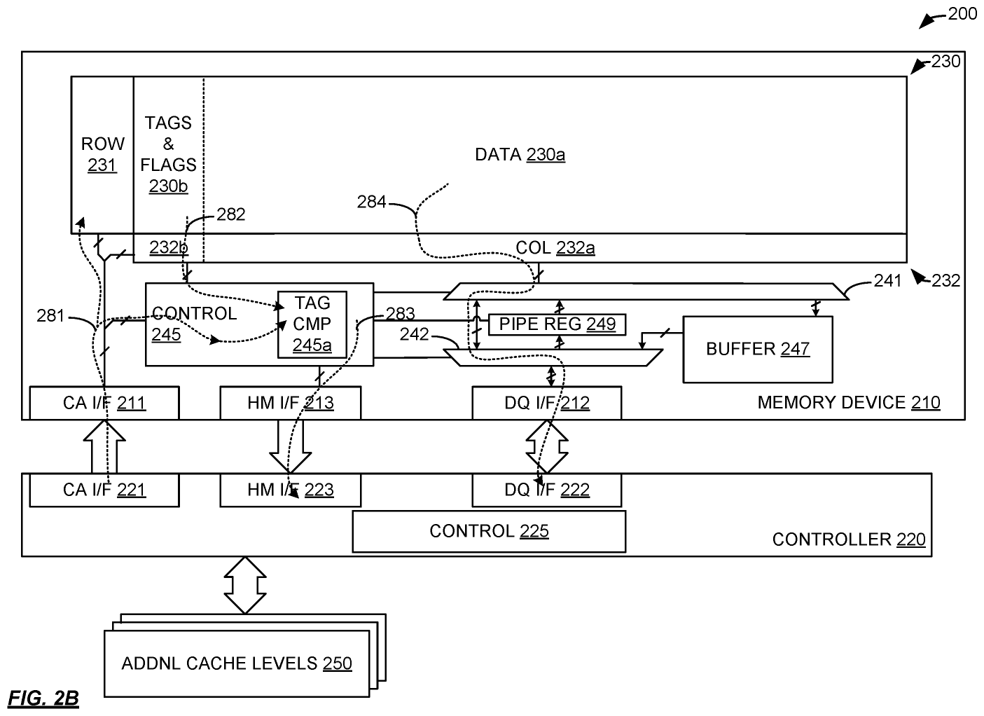

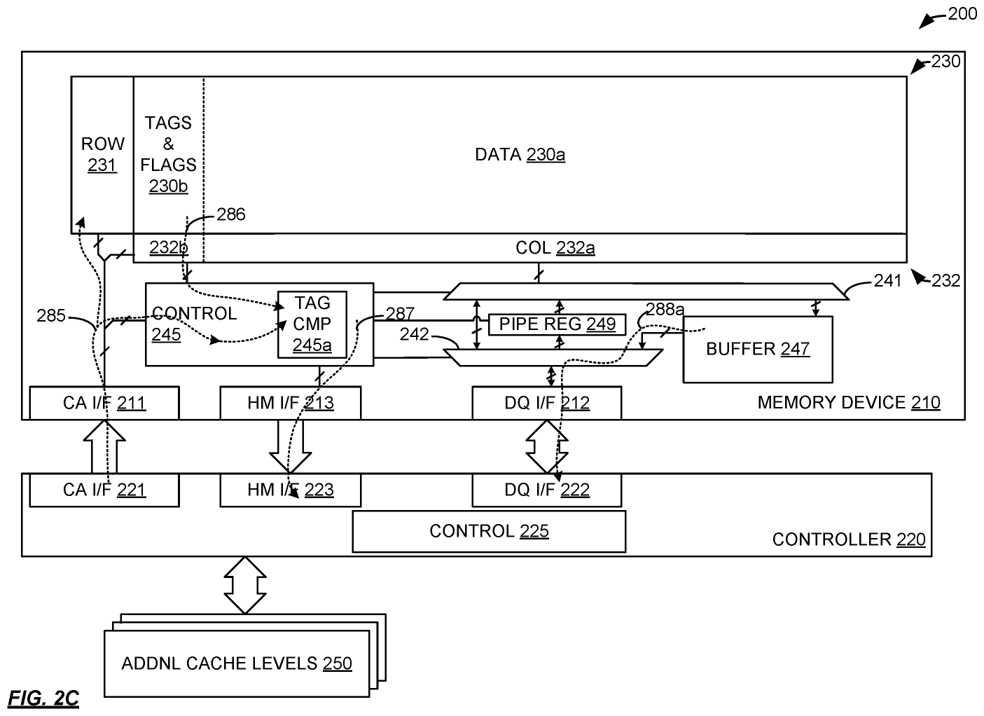

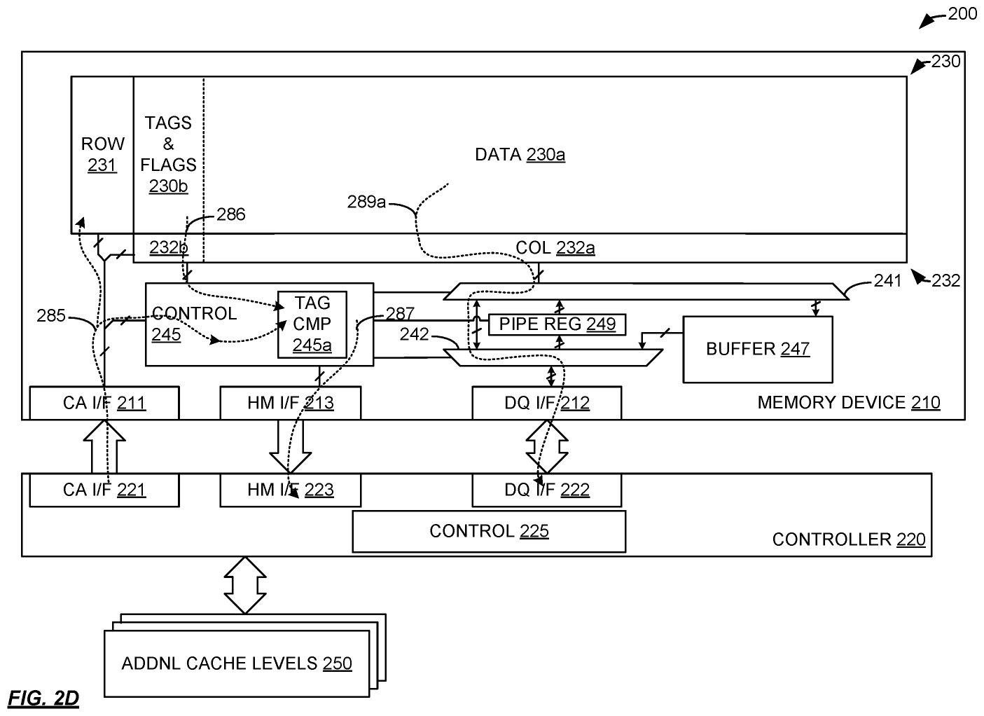

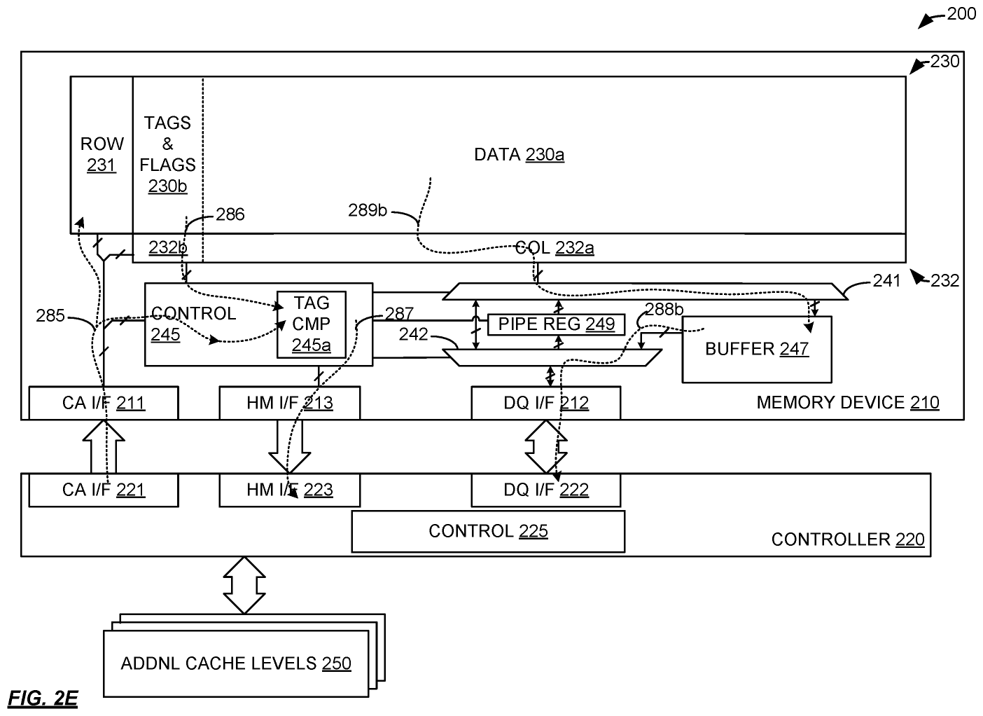

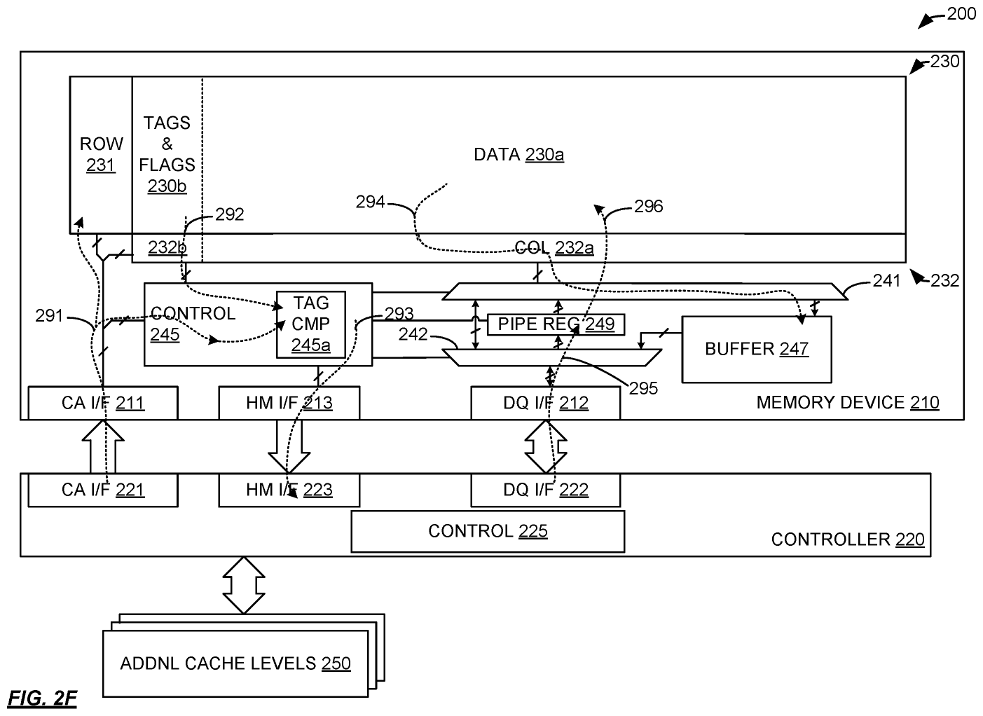

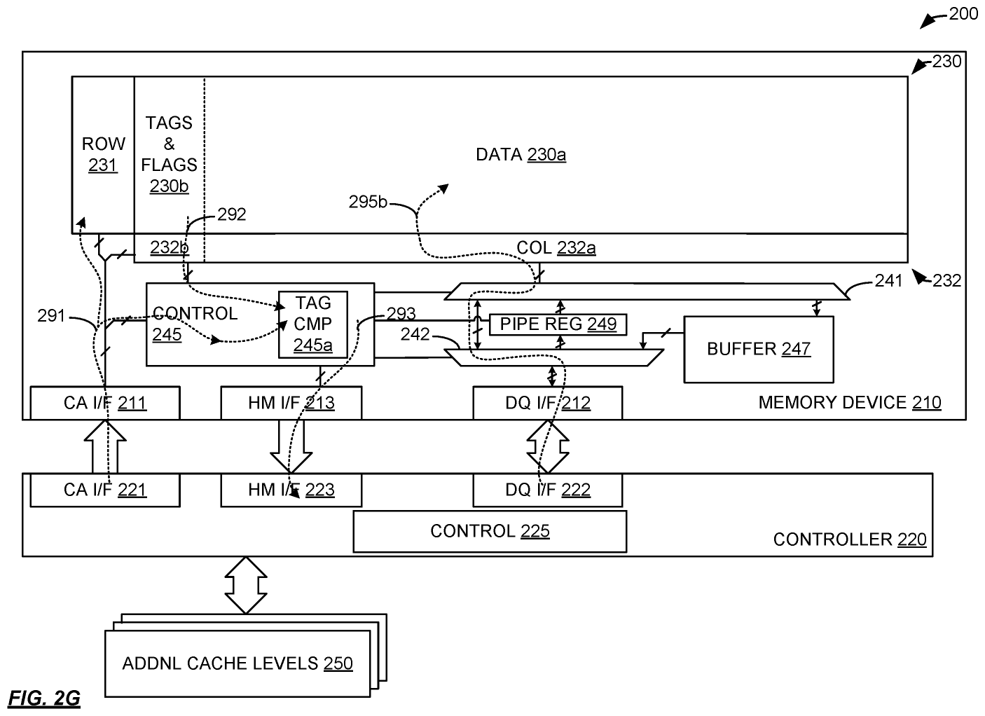

FIGS. 2A-2G are diagrams illustrating a memory system and caching adapted memory device operations. In FIGS. 2A-2G, memory system 200 comprises memory device 210 and memory controller 220. Memory device 210 includes command/address (CA) interface 211, data (DQ) interface 212, hit/miss (HM) interface 213, memory array 230, row circuitry 231, column circuitry 232, steering circuitry 241, steering circuitry 242, control circuitry 245, buffer circuitry 247, and pipeline register 249. Control circuitry 245 includes tag compare circuitry 245a. The rows and columns of memory array 230 may be organized into rows and columns of memory array tiles (MATs). Memory controller 220 includes CA interface 221, DQ interface 222, hit/miss (HM) interface 223, and control circuitry 225. Controller 220 is operatively coupled to additional cache levels 250, main memory (not shown in FIG. 2), and/or backing store (not shown in FIG. 2).

CA interface 221 of controller 220 is operatively coupled to CA interface 211 of memory device 210. CA interface 221 of controller 220 is operatively coupled to CA interface 211 of memory device 210 to at least communicate, from controller 220, commands, addresses, and cache tag query values to memory device 210. DQ interface 222 of controller 220 is operatively coupled to DQ interface 212 of memory device 210. DQ interface 222 of controller 220 is operatively coupled to DQ interface 212 of memory device 210 to communicate data (e.g., cache lines, dirty cache lines, cache line fill data) between controller 220 and memory device 210. HM interface 223 of controller 220 is operatively coupled to HM interface 213 memory device 210. HM interface 223 of controller 220 is operatively coupled to HM interface 213 of memory device 210 to at least communicate, from memory device 210, indicators of a cache tag compare result (i.e., hit or miss), and whether a cache access was to a clean or dirty cache line (e.g., cache flag indicators) to controller 220. In some embodiments, HM interface 213 of memory device 210 may also communicate cache tag values (e.g., the cache tag values associated with “dirty” cache lines being evicted so that controller 220 knows which lines are stored in buffer circuitry 247). In some embodiments, HM interface 213 of memory device 210 may communicate error information (e.g., indicators and/or information about ECC errors detected in cache tags and/or cache flags).

Memory controller 220 and memory device 210 may be integrated circuit type devices, such as are commonly referred to as “chips”. A memory controller, such as memory controller 220, manages the flow of data going to and from memory devices and/or memory modules. Memory device 210 may be a standalone device, or may be a component of a memory module such as a DIMM module used in servers. Memory device 210 may be, or be part of, a component having a “stack” of memory devices. Memory device 210 may be a device that adheres to, or is compatible with, a dynamic random access memory (DRAM) specification. A memory controller can be a separate, standalone chip, or integrated into another chip. For example, a memory controller 220 may be included on a single die with a microprocessor, included as a chip co-packaged with one or more microprocessor chips, included as part of a more complex integrated circuit system such as a block of a system on a chip (SOC), or be remotely coupled to one or more microprocessors via a fabric interconnect or other type of interconnect.

CA interface 211 of memory device 210 is operatively coupled to row circuitry 231, column circuitry 232, and control circuitry 245. CA interface 211 is operatively coupled to row circuitry 231 to at least to activate rows in memory array 230. CA interface 211 is operatively coupled to column circuitry 232 to at least sense values from activated rows, and to decode and communicate the values of selected columns with other circuitry of memory device 210 (e.g., steering circuitry 241, steering circuitry 242, buffer circuitry 247, pipeline register 249, DQ interface 212, etc.) CA interface 211 is operatively coupled to column circuitry 232 and control circuitry 245 to at least provide tag compare circuitry 245a with tag query values indicated by commands.

Memory array 230 of memory device 210 is logically subdivided into column groups 230a-230b (or MAT groups, columns of MATs, sections, assignments, fields, and/or associations). Column group 230a (a.k.a., cache line data field 230a) is to store cache lines. Column group 230b is to store cache tags and cache flags (a.k.a., cache tags and flags field 230b).

Column circuitry 232 is subdivided into column circuitry group 232a-232b that may have different decoding functions. Column circuitry group 232b is to decode a column address and communicate the addressed cache tags and cache flags with steering circuitry 241, control circuitry 245, and tag compare circuitry 245a. Column circuitry group 232a is to decode the column address and communicate the addressed cache line data with steering circuitry 241.

Steering circuitry 241 is operatively coupled to control circuitry 245, column circuitry 232, steering circuitry 242, buffer circuitry 247, and pipeline register 249. Steering circuitry 241 is operatively coupled to steering circuitry 242, buffer circuitry 247, and pipeline register 249 to, under the control of control circuitry 245, communicate data between memory array 230 (and column circuitry 232, in particular) and a selected one of steering circuitry 242, buffer circuitry 247, and pipeline register 249.

Steering circuitry 242 is operatively coupled to control circuitry 245, DQ interface 212, steering circuitry 241, buffer circuitry 247, and pipeline register 249. Steering circuitry 242 is operatively coupled to DQ interface 212, steering circuitry 241, buffer circuitry 247, and pipeline register 249 to, under the control of control circuitry 245, communicate data between DQ interface 212, and a selected one of steering circuitry 241, buffer circuitry 247, and pipeline register 249.

In an embodiment, controller 220, under the control of control circuitry 225, transmits a command to access a cache line and its associated tags in memory array 230 for reading the cache line. In addition to a column address and row address (e.g., decoded by row circuitry 231 and column circuitry 232, respectively), the cache access command communicates a tag query value. In other words, the tag query value corresponds to a tag value that the cache access operation is seeking to compare to a stored tag value to determine whether the cache line corresponding to the tag query value is present in memory device 210 at the specified address (row, bank, and column). In response to the cache access command, memory device 210 activates the addressed row into row sense amplifiers (e.g., in memory array 230), selects those columns associated with the received column address, and provides the stored values at those addressed columns to tag compare circuitry 245a and steering circuitry 241. This is illustrated in FIG. 2B by arrow 281 running from CA interface 221 through CA interface 211 to row circuitry 231, control circuitry 245, and tag compare circuitry 245a and arrow 282 running from tags and flags 230b to control circuitry 245, and tag compare circuitry 245a.

If tag compare circuitry 245a finds the tag query value matches (i.e., is equal to) the stored tag value in memory array 230 at the address communicated by (or in association with) the cache access command, and the “valid” flag indicates the cache entry is valid, it is termed a cache “hit” and the cache line that control circuitry 225 is seeking to read from memory device 210 is present and valid in memory array 230. Based on the cache hit, memory device 210 transmits a “hit” indicator to controller 220 via HM interface 213 and HM interface 223. A “dirty” or “clean” indicator may also be communicated on a hit to designate “clean-hit” or “dirty hit”. This is illustrated in FIG. 2B by arrow 283 running from tag compare circuitry 245a to controller 220 via HM I/F 213 and HM interface 223.

Since the command was a read operation, and based on an indicator of a “hit” (whether “clean” or “dirty”), memory device 210 transmits, via DQ interface 212 and DQ interface 222, the corresponding cache line data (e.g., from cache line data column circuitry group 232a) to controller 220 (e.g., by configuring steering circuitry 241 and steering circuitry 242). Based on one or more indicators, the read access command results in the accessed cache line from memory device 210 being transmitted to controller 220 without first being stored in buffer circuitry 247. In particular, in an embodiment, based on a first indicator (e.g., command opcode, command operand, command field value, cache tag match status from tag compare circuitry 245a, cache flag indicating cache line is “clean”, cache flag indicating cache line is “valid”, etc.), control circuitry 245 configures memory device 210 (and steering circuitry 241 and steering circuitry 242, in particular) to route cache line data 230a accessed from memory array 230 to controller 220 via column circuitry 232, steering circuitry 241, steering circuitry 242, DQ interface 212, and DQ interface 222. This is illustrated in FIG. 2B by arrow 284 running from cache line data 230a through steering circuitry 241, through steering circuitry 242, through DQ interface 212, to DQ interface 222.

In an embodiment, controller 220, under the control of control circuitry 225, transmits a command to access a cache line and its associated tags in memory array 230 for reading the cache line. In addition to a column address and row address (e.g., decoded by row circuitry 231 and column circuitry 232, respectively), the cache access command communicates a tag query value. In other words, the tag query value corresponds to a tag value that the cache access operation is seeking to compare to a stored tag value to determine whether the cache line corresponding to the tag query value is present in memory device 210 at the specified address (row, bank, and column). In response to the cache access command, memory device 210 activates the addressed row into row sense amplifiers (e.g., in memory array 230), selects those columns associated with the received column address, and provides the stored values at those addressed columns to tag compare circuitry 245a and steering circuitry 241. This is illustrated in FIGS. 2C-2E by arrow 285 running from CA interface 221 through CA interface 211 to row circuitry 231, control circuitry 245, and tag compare circuitry 245a and arrow 286 running from tags and flags 230b to control circuitry 245, and tag compare circuitry 245a.

If tag compare circuitry 245a finds the tag query value does not matches (i.e., is not equal to) the stored tag value in memory array 230 at the address communicated by (or in association with) the cache access command, or the “valid” flag indicates the cache entry is not valid, it is termed a cache “miss” and the cache line that control circuitry 225 is seeking to read from memory device 210 is either not present or not valid in memory array 230. Based on the cache miss, memory device 210 transmits a “miss” indicator to controller 220 via HM interface 213 and HM interface 223. A “dirty” or “clean” indicator may also be communicated on a miss to designate “clean-miss” or “dirty-miss”. This is illustrated in FIGS. 2C-2E by arrow 287 running from tag compare circuitry 245a to controller 220 via HM I/F 213 and HM interface 223.

In the case of a “clean-miss”, and since the command was a read operation memory device 210 transmits, via DQ interface 212 and DQ interface 222, cache line data from buffer circuitry 247 to controller 220 (e.g., by configuring steering circuitry 242). Based on one or more indicators, the read access command results in the accessed cache line from buffer circuitry 247 being transmitted to controller 220. In particular, in an embodiment, based on a first indicator (e.g., command opcode, command operand, command field value, cache tag match status from tag compare circuitry 245a is a “miss”, etc.), control circuitry 245 configures memory device 210 (and steering circuitry 241 and steering circuitry 242, in particular) to route a cache line of data accessed from buffer circuitry 247 to controller 220 via steering circuitry 242, DQ interface 212, and DQ interface 222. This is illustrated in FIG. 2C by arrow 288a running from buffer circuitry 247 through steering circuitry 242, through DQ interface 212, to DQ interface 222.

In an embodiment, in the case of a “dirty-miss”, and since the command was a read operation memory device 210 may transmit, via DQ interface 212 and DQ interface 222, the corresponding “dirty” cache line data (e.g., from cache line data column circuitry group 232a) to controller 220 (e.g., by configuring steering circuitry 241 and steering circuitry 242). Based on one or more indicators, the read access command results in the accessed “dirty” cache line from memory device 210 being transmitted to controller 220 without first being stored in buffer circuitry 247. In particular, in an embodiment, based on a first indicator (e.g., command opcode, command operand, command field value, cache tag match status from tag compare circuitry 245a, cache flag indicating cache line is “dirty”, cache flag indicating cache line is “valid”, etc.), control circuitry 245 configures memory device 210 (and steering circuitry 241 and steering circuitry 242, in particular) to route the “dirty” cache line data 230a accessed from memory array 230 to controller 220 via column circuitry 232, steering circuitry 241, steering circuitry 242, DQ interface 212, and DQ interface 222. This is illustrated in FIG. 2D by arrow 289a running from cache line data 230a through steering circuitry 241, through steering circuitry 242, through DQ interface 212, to DQ interface 222.

In another embodiment, in the case of a “dirty-miss”, and since the command was a read operation memory device 210 transmits, via DQ interface 212 and DQ interface 222, cache line data from buffer circuitry 247 to controller 220 (e.g., by configuring steering circuitry 242) and also stores the “dirty” cache line data from memory array 230 in buffer circuitry 247 without being immediately (or a fixed time later) transmitted to controller 220. Based on one or more indicators, the read access command results in the accessed cache line from buffer circuitry 247 being transmitted to controller 220 and the “dirty” cache line data from memory array 230 being stored in buffer circuitry 247. In particular, in an embodiment, based on a first indicator (e.g., command opcode, command operand, command field value, cache tag match status from tag compare circuitry 245a is a “miss”, etc.), control circuitry 245 configures memory device 210 (and steering circuitry 241 and steering circuitry 242, in particular) to route a cache line of data accessed from buffer circuitry 247 to controller 220 via steering circuitry 242, DQ interface 212, and DQ interface 222. This is illustrated in FIG. 2E by arrow 288b running from buffer circuitry 247 through steering circuitry 242, through DQ interface 212, to DQ interface 222. Control circuitry 245 also configures memory device 210 (and steering circuitry 241, in particular) to route the “dirty” cache line data 230a accessed from memory array 230 to buffer circuitry 247 via column circuitry 232, and steering circuitry 241. This is illustrated in FIG. 2E by arrow 289b running from data 230a through steering circuitry 241 to buffer circuitry 247.

In an embodiment, controller 220, under the control of control circuitry 225, transmits a command to access a cache line and its associated tags in memory array 230 for writing new data to the cache line. In addition to a column address and row address (e.g., decoded by row circuitry 231 and column circuitry 232, respectively), the cache access command communicates a tag query value. In other words, the tag query value corresponds to a tag value that the cache access operation is seeking to compare to a stored tag value to determine whether the cache line corresponding to the tag query value is present in memory device 210 at the specified address (row, bank, and column). In response to the cache access command, memory device 210 activates the addressed row into row sense amplifiers (e.g., in memory array 230), selects those columns associated with the received column address, and provides the stored values at those addressed columns to tag compare circuitry 245a and steering circuitry 241. This is illustrated in FIGS. 2F-2G by arrow 291 running from CA interface 221 through CA interface 211 to row circuitry 231, control circuitry 245, and tag compare circuitry 245a and arrow 292 running from tags and flags 230b to control circuitry 245, and tag compare circuitry 245a.

If tag compare circuitry 245a finds the tag query value does not matches (i.e., is not equal to) the stored tag value in memory array 230 at the address communicated by (or in association with) the cache access command, or the “valid” flag indicates the cache entry is not valid, it is termed a cache “miss” and the cache line that control circuitry 225 is seeking to read from memory device 210 is either not present or not valid in memory array 230. Based on the cache miss, memory device 210 transmits a “miss” indicator to controller 220 via HM interface 213 and HM interface 223. A “dirty” or “clean” indicator may also be communicated on a miss to designate “clean-miss” or “dirty-miss”. This is illustrated in FIGS. 2F-2G by arrow 293 running from tag compare circuitry 245a to controller 220 via HM I/F 213 and HM interface 223.

In the case of a “dirty-miss” and since the command was a write operation, memory device 210 receives cache line write data from controller 220 via DQ interface 212. Based on an indicator of a “miss” from tag compare circuitry 245a, and indicators that the current cache line being targeted for replacement is “dirty” and “valid”, memory device 210 routes the “dirty” cache line from memory array 230 to buffer circuitry 247. In particular, in an embodiment, based on a first indicator (e.g., command opcode, command operand, command field value, cache tag flags and match status from tag compare circuitry 245a indicating a “miss-dirty”, etc.), control circuitry 245 configures memory device 210 (and steering circuitry 241, in particular) to route the cache line being replaced in memory array 230 to buffer circuitry 247. This is illustrated in FIG. 2F by arrow 294 running from cache line data 230a to buffer circuitry 247 via steering circuitry 241. Control circuitry 245 also configures memory device 210 (and steering circuitry 242, in particular) to route the new cache line received from controller 220 to pipeline register 249. This is illustrated in FIG. 2F by arrow 295a running from DQ interface 222 through DQ interface 212 to pipeline register 249. Finally, after the cache line being replaced has been stored by buffer circuitry 247 so that column circuitry 232a is able to receive the new cache line without losing the contents of the cache line being replaced (because it is now stored in buffer circuitry 247), control circuitry 245 routes the new cache line from pipeline register 249 (via steering circuitry 241) to column circuitry 232a to be stored in memory array 230. This is illustrated in FIG. 2F by arrow 296 running from pipeline register 249 to column circuitry 232a to be stored in memory array 230.

In the case of a “clean-miss” and since the command was a write operation, memory device 210 receives cache line write data from controller 220 via DQ interface 212. Based on an indicator of a “miss” from tag compare circuitry 245a, and indicators that the current cache line being targeted for replacement is “clean”, control circuitry 245 configures memory device 210 (and steering circuitry 241 and steering circuitry 242, in particular) to route the new cache line received from controller 220 to memory array 230. This is illustrated in FIG. 2G by arrow 295b running from DQ interface 222 through DQ interface 212, steering circuitry 242, steering circuitry 241 to column circuitry 232a to be stored in memory array 230.

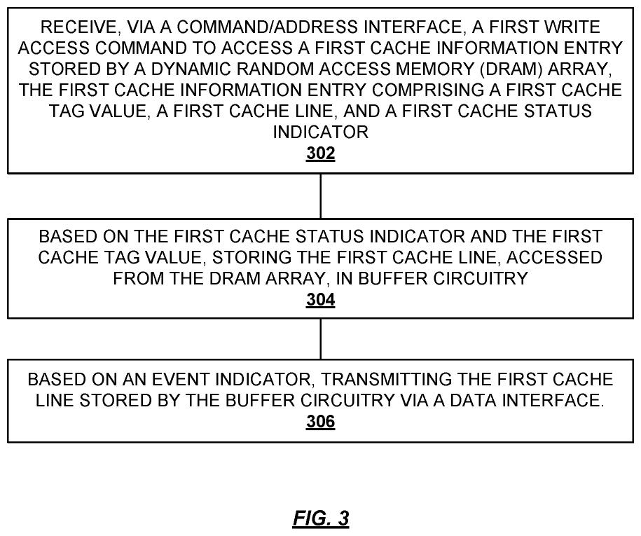

FIG. 3 is a flowchart illustrating a method of operating a memory component with a flush buffer. One or more of the steps illustrated in FIG. 3 may be performed by, for example, memory system 100, memory system 200, and/or their components. Via a command/address interface, a first write access command to access a first cache information entry stored by a dynamic random access memory (DRAM) array is received, where the first cache information entry comprises a first cache tag value, a first cache line, and a first cache status indicator (302). For example, memory device 210 may receive, from controller 220 and via CA interface 211, a write access command to access a cache information entry stored in memory array 230, where each row of memory array 230 comprises cache line data (e.g., in cache line data field 230a), a cache tag value and at least one cache flag value (e.g., in cache tags and flags field 230b).

Based on the first cache status indicator and the first cache tag value, the first cache line, accessed from the DRAM array, is stored in buffer circuitry (304). For example, based on the cache tag value from the accessed cache information entry not matching the tag associated with the first write access command (i.e., a “miss”) and a cache flag value from the accessed cache information entry indicating the cache line is valid and has been modified (i.e., is “dirty”), the accessed cache line may be stored in buffer circuitry 247.

Based on an event indicator, the first cache line stored by the buffer circuitry is transmitted via a data interface (306). For example, based on an explicit command to memory device 210 from controller 220, a write-to-read command sequence, a refresh operation, or an indicator the DQ bus will be unused, memory device 210 may read the accessed cache line from buffer circuitry 247 and transmit it to controller 220 via DQ interface 212.

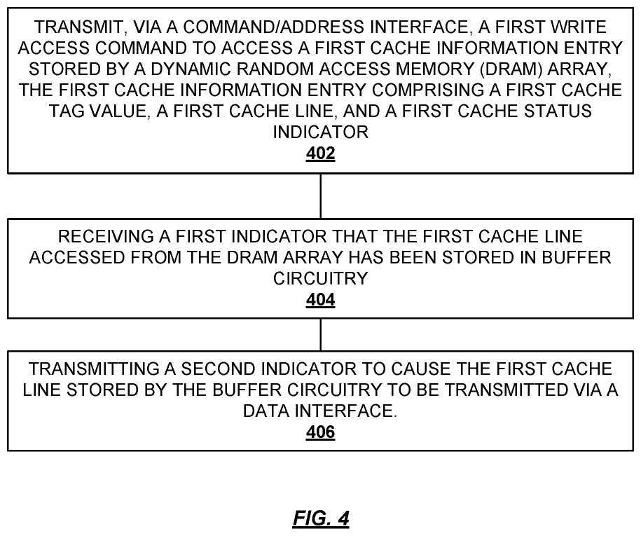

FIG. 4 is a flowchart illustrating a method of operating a memory controller. One or more of the steps illustrated in FIG. 4 may be performed by, for example, memory system 100, memory system 200, and/or their components. Via a command/address interface, a first write access command to access a first cache information entry stored by a dynamic random access memory (DRAM) array is transmitted, where the first cache information entry comprises a first cache tag value, a first cache line, and a first cache status indicator (402). For example, controller 220 may transmit, to memory device 210 and via CA interface 221, a write access command to access a cache information entry stored in memory array 230 of memory device 210, where each row of memory array 230 comprises cache line data (e.g., in cache line data field 230a), a cache tag value and at least one cache flag value (e.g., in cache tags and flags field 230b).

A first indicator that the first cache line access from the DRAM array has been stored in buffer circuitry is received (404). For example, controller 220 may receive, from memory device 210 and via HM interface 223, and indicator that the write access command resulted in a “dirty-miss” thereby indicating to controller 220 that memory device 210 will be storing the cache line being replaced in buffer circuitry 247. A second indicator is transmitted to cause the first cache line stored by the buffer circuitry to be transmitted via a data interface (406). For example, controller 220 may indicate to memory device 210 that memory device 210 should transmit the replaced cache line data via DQ interface 212 using one or more of an explicit command to memory device 210, a write-to-read command sequence, a refresh operation, or an indicator the DQ bus will be unused.

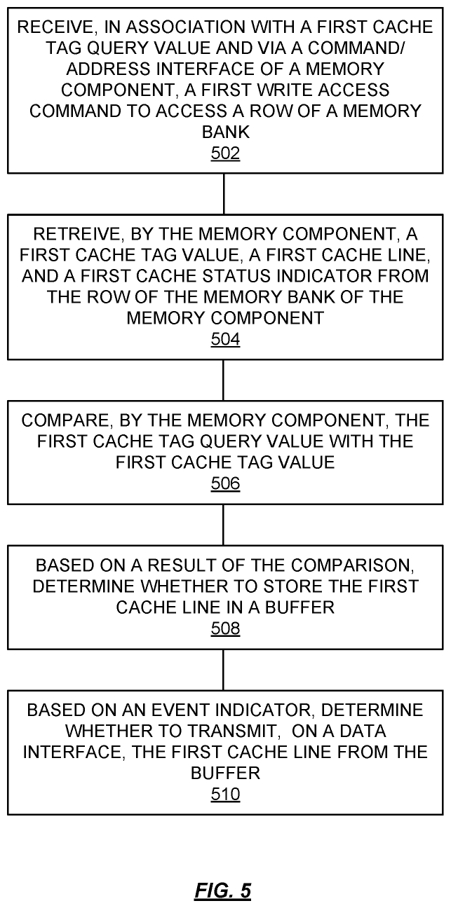

FIG. 5 is a flowchart illustrating a method of operating a memory component having cache tag based flush buffer management. One or more of the steps illustrated in FIG. 5 may be performed by, for example, memory system 100, memory system 200, and/or their components. In association with a first cache tag query value and via a command/address interface of a memory component, a first write access command to access a row of a memory bank is received (502). For example, memory device 210 may receive, from controller 220 and via CA interface 111, a write access command and associated cache tag query value.

By the memory component, a first cache tag value, a first cache line, and a first cache status indicator are retrieved from the row of the memory bank of the memory component (504). For example, a cache tag value, cache line data, and one or more cache flags may be retrieved from memory array 230 by memory device 210. By the memory component, the first cache tag query value and the first cache tag value are compared (506). For example, tag compare circuitry 245a may compare the cache tag query value received from controller 220 with the cache tag value retrieved from memory array 230.

Based on a result of the comparison, it is determined whether to store the first cache line in a buffer (508). For example, based on the comparison of the cache tag query value received from controller 220 with the cache tag value retrieved from memory array 230, memory device 210 may determine that the cache tag query value is a cache “miss”. Based on memory device 210 determining that the write access is a “miss”, memory device may store the cache line being replaced (i.e., the cache line retrieved from memory array 230 in response to the write access command) in buffer circuitry 247. Based on an event indicator, it is determined whether to transmit, on a data interface, the first cache line from the buffer (510). For example, based on the occurrence of one or more of an explicit command to memory device 210, a write-to-read command sequence, a refresh operation, or an indicator the DQ bus will be unused, memory device 210 may retrieve from buffer circuitry 247 and transmit the cache line that was replaced (i.e., the cache line retrieved from memory array 230 in response to the write access command) to controller 220 via DQ interface 212. Similarly, based on the lack of occurrence of one or more of an explicit command to memory device 210, a write-to-read command sequence, a refresh operation, or an indicator the DQ bus will be unused, memory device 210 may not transmit a cache line from buffer circuitry 247.

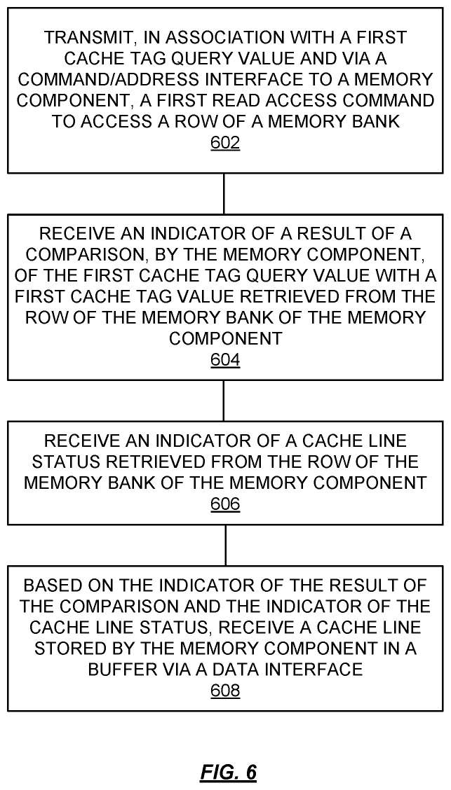

FIG. 6 is a flowchart illustrating a method of operating a controller to use cache tag based flush buffer management. One or more of the steps illustrated in FIG. 6 may be performed by, for example, memory system 100, memory system 200, and/or their components. In association with a first cache tag query value and via a command/address interface, a first read access command to access a row of a memory bank is transmitted to a memory component (602). For example, controller 220 may transmit, to memory device 210 and via CA interface 121, a write access command and associated cache tag query value.

An indicator of a result of a comparison, by the memory component, of the first cache tag query value with a first cache tag value retrieved from the row of the memory bank of the memory component is received (604). For example, controller 220 may receive, via HM interface 223, an indicator of whether the cache tag query value was a “hit” or a “miss” with the cache information entry retrieved from memory array 230 in response to the read access command.

An indicator of a cache line status retrieved from the row of the memory bank of the memory component is received (606). For example, indicators of whether the cache information entry retrieved from memory array 230 in response to the read access command is “dirty”, “clean”, “valid”, or “invalid” may be received by controller 220 (e.g., via HM interface 223). Based on the indicator of the result of the comparison and the indicator of the cache line status, a cache line stored by the memory component in a buffer is received via a data interface (608). For example, based on the indicator of the comparison indicating a “miss”, and the indicator based on one or more cache flags indicating the accessed cache line is “clean”, memory device 210 may transmit, and controller 220 receive, a cache line from buffer circuitry 247 because the DQ interface 212 and DQ interface 222 would otherwise not be communicating data (because the accessed cache line is not the one controller 220 was looking for).

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of memory system 100, and/or memory system 200, and their components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3½ inch floppy media, CDs, DVDs, and so on.

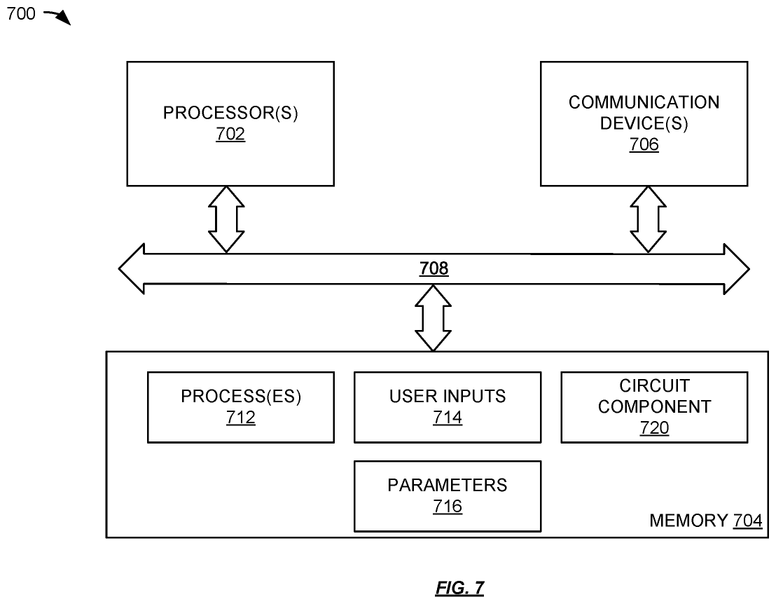

FIG. 7 is a block diagram illustrating one embodiment of a processing system 700 for including, processing, or generating, a representation of a circuit component 720. Processing system 700 includes one or more processors 702, a memory 704, and one or more communications devices 706. Processors 702, memory 704, and communications devices 706 communicate using any suitable type, number, and/or configuration of wired and/or wireless connections 708.

Processors 702 execute instructions of one or more processes 712 stored in a memory 704 to process and/or generate circuit component 720 responsive to user inputs 714 and parameters 716. Processes 712 may be any suitable electronic design automation (EDA) tool or portion thereof used to design, simulate, analyze, and/or verify electronic circuitry and/or generate photomasks for electronic circuitry. Representation 720 includes data that describes all or portions of memory system 100, and/or memory system 200, and their components, as shown in the Figures.

Representation 720 may include one or more of behavioral, register transfer, logic component, transistor, and layout geometry-level descriptions. Moreover, representation 720 may be stored on storage media or communicated by carrier waves.

Data formats in which representation 720 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email

User inputs 714 may comprise input parameters from a keyboard, mouse, voice recognition interface, microphone and speakers, graphical display, touch screen, or other type of user interface device. This user interface may be distributed among multiple interface devices. Parameters 716 may include specifications and/or characteristics that are input to help define representation 720. For example, parameters 716 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 704 includes any suitable type, number, and/or configuration of non-transitory computer-readable storage media that stores processes 712, user inputs 714, parameters 716, and circuit component 720.

Communications devices 706 include any suitable type, number, and/or configuration of wired and/or wireless devices that transmit information from processing system 700 to another processing or storage system (not shown) and/or receive information from another processing or storage system (not shown). For example, communications devices 706 may transmit circuit component 720 to another system. Communications devices 706 may receive processes 712, user inputs 714, parameters 716, and/or circuit component 720 and cause processes 712, user inputs 714, parameters 716, and/or circuit component 720 to be stored in memory 704.

Implementations discussed herein include, but are not limited to, the following examples:
Example 1: A memory component, comprising: a dynamic random access memory (DRAM) array to store information entries; a command/address interface to receive a first write access command; and control circuitry to, based on a first indicator, store first data accessed from the DRAM array in response to the first write access command in buffer circuitry, and to, based on a second indicator, transmit the first data stored in the buffer circuitry via a data interface.
Example 2: The memory component of example 1, wherein the first indicator is associated with an address of the first write access command.
Example 3: The memory component of example 1, wherein the first indicator is associated with a write-miss-dirty condition for the address of the first write access command.
Example 4: The memory component of example 1, wherein the second indicator is associated with a buffer access command.
Example 5: The memory component of example 1, wherein the second indicator is associated with a write to read sequence of access commands.
Example 6: The memory component of example 1, wherein the second indicator is associated with a refresh command.
Example 7: The memory component of example 1, wherein the second indicator is associated with cycles on the data interface that are not communicating data for a read access command and not transferring data for a second write access command.
Example 8: A memory component, comprising: a dynamic random access memory (DRAM) array to store a plurality of cache information entries, each cache information entry comprising a tag field, a cache line, and at least one cache line status indicator; a command/address interface to receive a first write access command, in association with a first tag query value, to access a first cache information entry comprising a first tag value, a first cache line, and a first cache line status indicator; a buffer to, based on the first cache line status indicator, store the first cache line; and a data interface to, based on an event indicator, transmit the first cache line stored in the buffer.
Example 9: The memory component of example 8, wherein the event indicator is associated with a command, received via the command/address interface, to access the first cache line from the buffer.
Example 10: The memory component of example 8, wherein the event indicator is associated with a sequence of commands received via the command/address interface.
Example 11: The memory component of example 8, wherein the event indicator is associated with a command, received via the command/address interface, that results a period of time where data to and from the DRAM array is not to be communicated via the data interface.
Example 12: The memory component of example 8, wherein the sequence of commands comprises a write command followed by a read command.
Example 13: The memory component of example 8, wherein the sequence of commands results a period of time where data from the DRAM array is not to be communicated via the data interface.
Example 14: The memory component of example 8, wherein the first cache line status indicator is associated with the first write access command being directed to a second cache line that is not the first cache line and being associated with the first cache line being in a modified state.
Example 15: A method of operating a memory component, comprising: receiving, via a command/address interface, a first write access command to access a first cache information entry stored by a dynamic random access memory (DRAM) array, the first cache information entry comprising a first cache tag value, a first cache line, and a first cache status indicator; based on the first cache status indicator and the first cache tag value, storing the first cache line accessed from the DRAM array in buffer circuitry; and based on an event indicator, transmitting the first cache line stored by the buffer circuitry via a data interface.
Example 16: The method of example 15, wherein the first cache status indicator and the first cache tag value is associated with a write-miss-dirty condition for the first cache line.
Example 17: The method of example 15, wherein the event indicator is associated with a command to access the buffer circuitry to receive the first cache line.
Example 18: The method of example 15, wherein the event indicator is associated with a sequence of a plurality of commands.
Example 19: The method of example 18, wherein the sequence of the plurality of commands is to result in a period of time where data to and from the DRAM array is not to be directly communicated via the data interface and the first cache line is transmitted during the period of time.
Example 20: The method of example 15, wherein the event indicator is associated with a command, received via the command/address interface, that results a period of time where data to and from the DRAM array is not to be directly communicated via the data interface and the first cache line is transmitted during the period of time.
Example 21: A method of operating a memory component, comprising: receiving, via a command/address interface, a read access command to access a first cache information entry stored by a dynamic random access memory (DRAM) array, the first cache information entry comprising a first cache tag value, a first cache line, and a first cache status indicator; and based on the first cache status indicator and the first cache tag value, storing the first cache line accessed from the DRAM array in buffer circuitry and transmitting the a second cache line stored by the buffer circuitry via a data interface.
Example 22: The method of example 21, wherein the first cache status indicator and the first cache tag value is associated with a read-miss-dirty condition for the first cache line.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A memory component, comprising:
a dynamic random access memory (DRAM) array to store information entries;
a command/address interface to receive a first write access command; and
control circuitry to, based on a first indicator, store first data accessed from the DRAM array in response to the first write access command in buffer circuitry, and to, based on a second indicator, transmit the first data stored in the buffer circuitry via a data interface.

2. The memory component of claim 1, wherein the first indicator is associated with an address of the first write access command.

3. The memory component of claim 1, wherein the first indicator is associated with a write-miss-dirty condition for the address of the first write access command.

4. The memory component of claim 1, wherein the second indicator is associated with a buffer access command.

5. The memory component of claim 1, wherein the second indicator is associated with a write to read sequence of access commands.

6. The memory component of claim 1, wherein the second indicator is associated with a refresh command.

7. The memory component of claim 1, wherein the second indicator is associated with cycles on the data interface that are not communicating data for a read access command and not transferring data for a second write access command.

8. A memory component, comprising:
a dynamic random access memory (DRAM) array to store a plurality of cache information entries, each cache information entry comprising a tag field, a cache line, and at least one cache line status indicator;
a command/address interface to receive a first write access command, in association with a first tag query value, to access a first cache information entry comprising a first tag value, a first cache line, and a first cache line status indicator;
a buffer to, based on the first cache line status indicator, store the first cache line; and
a data interface to, based on an event indicator, transmit the first cache line stored in the buffer.

9. The memory component of claim 8, wherein the event indicator is associated with a command, received via the command/address interface, to access the first cache line from the buffer.

10. The memory component of claim 8, wherein the event indicator is associated with a sequence of commands received via the command/address interface.

11. The memory component of claim 8, wherein the event indicator is associated with a command, received via the command/address interface, that results a period of time where data to and from the DRAM array is not to be communicated via the data interface.

12. The memory component of claim 8, wherein the sequence of commands comprises a write command followed by a read command.

13. The memory component of claim 8, wherein the sequence of commands results a period of time where data from the DRAM array is not to be communicated via the data interface.

14. The memory component of claim 8, wherein the first cache line status indicator is associated with the first write access command being directed to a second cache line that is not the first cache line and being associated with the first cache line being in a modified state.

15. A method of operating a memory component, comprising:
receiving, via a command/address interface, a first write access command to access a first cache information entry stored by a dynamic random access memory (DRAM) array, the first cache information entry comprising a first cache tag value, a first cache line, and a first cache status indicator;
based on the first cache status indicator and the first cache tag value, storing the first cache line accessed from the DRAM array in buffer circuitry; and
based on an event indicator, transmitting the first cache line stored by the buffer circuitry via a data interface.

16. The method of claim 15, wherein the first cache status indicator and the first cache tag value is associated with a write-miss-dirty condition for the first cache line.

17. The method of claim 15, wherein the event indicator is associated with a command to access the buffer circuitry to receive the first cache line.

18. The method of claim 15, wherein the event indicator is associated with a sequence of a plurality of commands.

19. The method of claim 18, wherein the sequence of the plurality of commands is to result in a period of time where data to and from the DRAM array is not to be directly communicated via the data interface and the first cache line is transmitted during the period of time.

20. The method of claim 15, wherein the event indicator is associated with a command, received via the command/address interface, that results a period of time where data to and from the DRAM array is not to be directly communicated via the data interface and the first cache line is transmitted during the period of time.
